(19) United States
(12) Patent Application Publication
(10) Pub. No.: US 2007/0000945 A1
(43) Pub. Date: Jan. 4, 2007

(54) Supply container and sealing cap for a supply container

(76) Inventors: Rainer Geberzahn, Juchen (DE); Hans Georg Muhlhausen, Dusseldorf (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/451,843

(22) Filed: Jun. 13, 2006

Related U.S. Application Data
(63) Continuation of application No. PCT/EP04/12325, filed on Oct. 30, 2004.

(30) Foreign Application Priority Data
Dec. 13, 2003 (DE) 103 58 433.1

(51) Int. Cl. B67D 5/56; B65D 47/00

(52) U.S. Cl. 222/129; 222/562

(57) ABSTRACT

The invention relates to a supply container comprising a multi-compartment receiving container which is sealed by a sealing cap. The sealing cap seals at least two openings respectively formed by nozzles of the multi-compartment receiving container and is connected to the receiving container in a sealed state in a friction-tight and/or positive locking fit. A sealing area on the cap is associated with each opening and in a sealed state the associated sealing area rests on the lip of the corresponding opening in a sealing manner. In a sealed state, the sealing cap assumes a precisely determined sealing position on the receiving container, wherein the sealing areas rest on the lips and a small axial pressing force is exerted.

### CROSS REFERENCE TO RELATED APPLICATIONS

This application is a §365 (c) continuation application of PCT/EP2004/012325 filed Oct. 30, 2004, which in turn claims priority of DE Application 103 58 433.1 filed Dec. 13, 2003 each of the foregoing applications is incorporated herein by reference.

### FIELD OF THE INVENTION

The invention relates to a supply container having at least two compartments, each with a separate discharge opening, and a cap covering the two discharge openings.

### BACKGROUND OF THE INVENTION

The term supply container is used as a general term for receiving containers, in particular plastic bottles, for fluids containing an active substance, such as cleaning agents and disinfectants. It is known to use supply containers with multiple compartments and a common sealing cap for the multi-compartment receiving container if it is wished to simultaneously apply a number of fluids containing an active substance which are intended to be or have to be kept separately from one another. For specific details, reference may be made here to the parallel German patent application 102 38 431.2 (DE 102 38 431 A1), which represents prior art not published before the priority date and the full content of the disclosure of which is also incorporated by reference in the disclosure of the present patent application. This prior art which was not published before the priority date also includes extensive references to further prior art which was published before the priority date.

This prior art which was not published before the priority date already proposes measures as to how in the case of a supply container of the type in question, in which the possibly multi-compartment receiving container has in any event at least two openings, respectively formed with a lip, for a fluid containing an active substance to leave, these openings can at the same time be effectively sealed. However, although the cone seals provided here for both openings are effective with regard to the sealing in relation to the respective opening, they are problematical in terms of technical aspects of production, because they require very close tolerances in the production of the sealing cap and the receiving container.

Although prior art published before the priority date (GB 2 293 157 A) discloses the sealing of two openings respectively formed by lips of a multi-compartment receiving container by means of a sealing cap, this takes place by means of indirect sealing of a mixing chamber formed in the sealing cap downstream from the two openings. This sealing technique cannot be used for the separate sealing of the two compartments of the receiving container.

The teaching is based on the problem of optimizing the supply container that is known from the aforementioned prior art published before the priority date in such a way that the openings can each in themselves be effectively sealed simultaneously.

### SUMMARY OF THE INVENTION

The claimed supply container solves the aforementioned problem by providing sealing areas on the cap associated with registry with the openings, and assuring proper axial pressing force to effect a seal of the openings.

According to the invention, it has been found that solutions for the sealing of openings which can be chosen in the case of a supply container with only one opening to be sealed do not lead to optimum results in the case of sealing caps for supply containers with at least two openings to be sealed.

According to the invention, optimized sealing of the openings by the sealing cap is realized by the seal being ensured by a dedicated sealing area resting on the lip of the associated opening in an abutting, sealing manner. Resting in an abutting manner means here that the sealing area of the sealing cap is only placed against the lip in the axial direction in relation to the opening. This takes place under a certain axial pressing force, so that secure enforced sealing is achieved, because the sealing cap assumes a precisely determined sealing position in the sealed state of the supply container. The solution according to the invention means that lateral displacements of the sealing area in relation to the lip of the opening are possible in a considerably greater range of tolerances than in the case of the sealing techniques known from the prior art for individual sealing caps.

A particularly expedient refinement of the supply container according to the invention is obtained if both the sealing cap and the receiving container consist-of plastic and are made from two different plastics, to be specific plastics with different. Shore hardnesses. The components are made to bear against each other at the openings for the purpose of sealing.

The teaching according to the invention can be realized particularly expediently if the sealing cap is placed or, in particular, snap-fitted onto the receiving container with frictional engagement in a specific sealing position.

Additional sealing elements are not required in the case of the supply container according to the invention. If appropriate materials are used, in particular appropriate plastics, a transparency of the supply container can also be achieved in the region of the sealing cap, which also comprises the region of the openings.

In a preferred embodiment, the supply container according to the invention is embodied as a dispensing bottle, as is the subject of the earlier German patent application 102 38 431.2. Reference is made once again here to this published German patent application, which was not published before the priority date. The full content of its disclosure is incorporated by reference into the disclosure of the present patent application.

### BRIEF DESCRIPTION OF THE DRAWINGS

The invention is explained in more detail below on the basis of the drawing, which merely represents preferred exemplary embodiments and in which:

FIG. 1 shows an exemplary embodiment of a supply container according to the invention in a perspective view,

FIG. 2 shows the region of the sealing cap of a supply container from FIG. 1 in section and in a schematically simplified form and

FIG. 3 shows a further exemplary embodiment of the invention in a simplified representation corresponding to FIG. 2.

### DESCRIPTION OF PREFERRED EMBODIMENTS

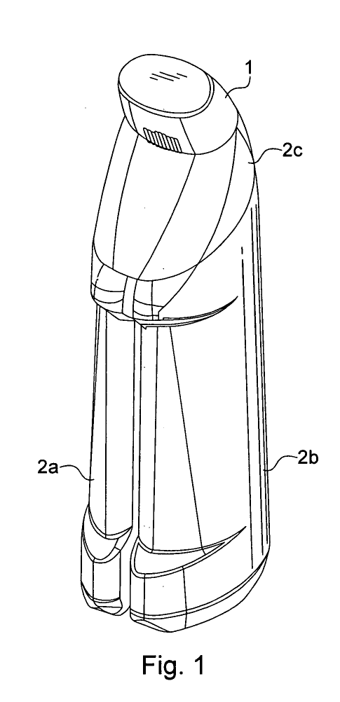

FIG. 1 shows in a representation which is taken from the German patent application to which reference is made, a supply container with a receiving container 2 sealed by a sealing cap 1. In the exemplary embodiment represented, this receiving container is embodied as a two-compartment container, that is to say has two interconnected part-containers 2a, 2b. These part-containers have internal compartments( not shown), each may adapted to receive a fluid containing an active substance, so that fluids containing an active substance that are not stable in storage can be stored and jointly applied with such a supply container 2. However, the teaching of the invention is not restricted to supply containers with a receiving container 2 comprising a number of part-containers 2a, 2b, but is concerned generally with a supply container with a receiving container 2.

In the case of the particular supply container that is represented in FIG. 1, with two part-containers 2a, 2b, it goes without saying that each part-container has single chamber and at least one outlet for the fluid containing an active substance that is located in it. However, even in the case of a single, contiguous receiving container 2, it may be expedient to provide a number of outlets. In this respect, it is also provided here that a head piece 2c, which is shared by the two part-containers 2a, 2b, accommodates the outlets. The head piece may be part of a container having two integral chambers, or may be a connector for two separate containers, each with a chamber and an outlet for a fluid containing an active substance.

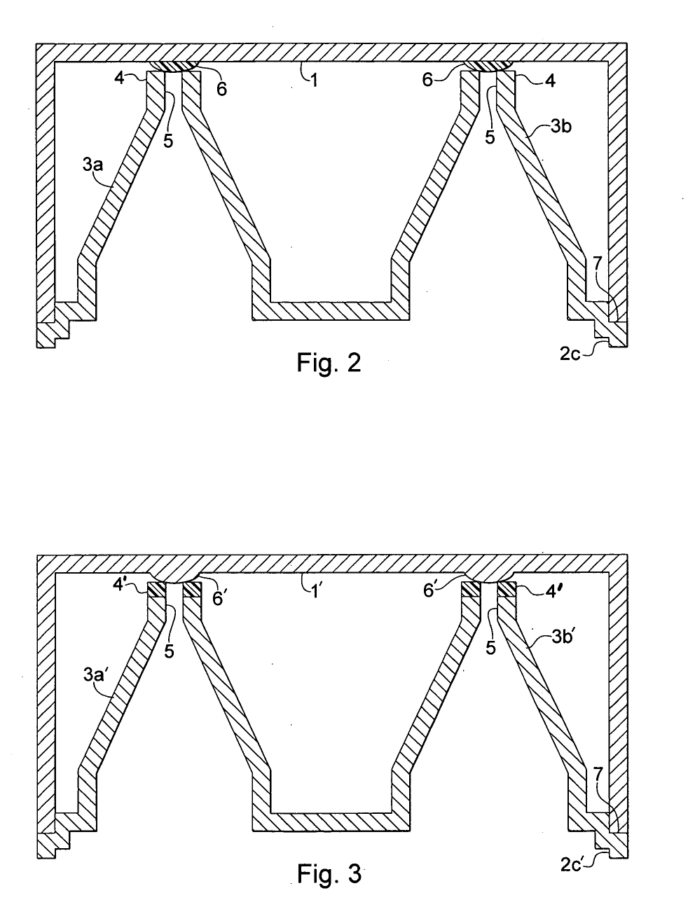

FIG. 2 schematically shows a preferred exemplary embodiment of a supply container according to the invention, in which the sealing cap 1 is placed on the upper end, schematically indicated here, of the receiving container 2 or of the head piece 2c. In the represented exemplary embodiment of FIG. 2, it is evidently the case that the receiving container 2 has a contiguous receiving volume for a fluid containing an active substance. If a receiving container 2 with two part-containers 2a, 2b is provided here, as in FIG. 1, the two compartments of the receiving container 2 must be separate from each other. Respective nozzles 3a and 3b, via which the fluid containing an active substance that is located in the receiving container 2 can be fed to the respective outlet, can be seen here on the receiving container 2. Each nozzle may be formed integrally with its associated compartment, or the head piece 2c may be formed separately, and each nozzle may be connected to a separate compartment during assembly of the container 2.

According to the invention, it is now the case that the sealing cap 1 serves for simultaneously sealing at least two openings 5 on the receiving container 2, which are respectively formed by an lip 4, here at the nozzle 3. An opening 5 may be of a round, or oval, polygonal, in particular triangular or rectangular form, as well as slot-shaped or star-shaped. In this respect, it is provided that, in the sealed state, the sealing cap 1 is connected to the head piece 2a of the receiving container 2, as represented in FIG. 2, securely, though detachably. As can be found in various variants in the prior art (EP 0 570 276 B1, EP 0 839 735 B1, WO 03/059768 A1, EP 0 743 259 B1), this connection may be made with frictional or positive engagement, for example also a combination of frictional engagement by a press fit and positive engagement by a snap fit.

In the prior art, sealing caps seal openings formed by an lip for example with a cone seal. It has been found that this manner of sealing corresponding openings is problematical when a number of openings are sealed simultaneously. The teaching of the invention therefore proposes that a sealing area 6 is present or formed on the sealing cap 1 in relation to each opening 5 and, in the sealed state, as represented in FIG. 2, the respective sealing areas 6 come to rest on the lips 4 of the openings 5 in an abutting, sealing manner. Such abutment, merely taking the form of a pressure-exerting seal, is less sensitive to tolerances than typical cone seals, as are normally often used for sealing caps of the type in question.

Secure sealing of the openings 5 by the sealing areas 6 of the sealing cap 1 requires a minimum sealing pressure. For this, it is provided that, in the sealed state of the supply container, the sealing cap 1 on the receiving container 2 assumes a precisely determined sealing position in which the sealing areas 6 come to rest on the lips 4 with a small axial pressing force being exerted. This effect is already obtained from the intrinsic elasticity of the sealing cap 1, in any event if it is produced from thermoplastic material.

In the case of a frictionally engaging connection of the sealing cap 1 to the receiving container 2, exact handling on the part of the user is required to realize a pressure-exerting force that can be reproducibly established. Therefore, according to a preferred teaching, it is recommendable to connect the sealing cap 1 to the receiving container 2 with positive engagement, for example by means of a snap-fitting connection. In principle, it is also possible to realize a screw connection, for example as a quick screw coupling (screwing motion only over a small part of a full circle), if the sealing areas 6 of the sealing cap 1 are formed in an arcuate path which registers with the lips in a correspondingly matching manner.

It is important that, when the sealing cap 1 reaches the sealed state on the receiving container 2, both openings 5 of the receiving container 2 are closed by means of the sealing areas 6 in an enforced and effectively sealing manner. In the exemplary embodiment that is represented and preferred, achieving the sealing position is indicated or ensured by abutting edges coming to rest on each other as indicated at 7.

In principle, it is possible and, with the lips 4 of the openings 5 appropriately formed for example with a convex contour, also expedient merely to define the sealing areas 6 of the sealing caps 1 geometrically, that is to say not specially form them physically. However, this is not represented in the drawings. In such a case, the inner surface of the sealing cap 1 could in principle be of a smooth form. The sealing areas 6 of the sealing cap 1 would be areas which rest on the lips 4 of the openings 5 and lead to the desired sealing effect when the sealing cap 1 is in the sealing position.

However, the exemplary embodiment that is represented and preferred to this extent shows a different form, to be specific such that the sealing areas 6 of the sealing cap 1 are formed in each case as a lenticular convexity on the material of the sealing cap 1. Particularly effective sealing is obtained here by the linear contact between the lip 4 and the lenticularly formed sealing area 6. The same applies correspondingly to other shapes of the convexity, for example a part-spherical form of the convexity.

It can generally be provided that the lip 4 and/or the sealing area 6 consist of a thermoplastic material. In the exemplary embodiment represented, it is the case in this respect that the sealing cap 1 and the receiving container 2 consist of a thermoplastic material. The material of the receiving container 2 is preferably a polyolefin, in particular a polypropylene (PP), a polyethylene (PE), a polyvinyl chloride (PVC), a polyethylene terephthalate (PET) or a glycol-modified polyethylene terephthalate (PETG).

A similar type of material can also be used for the sealing cap 1. However, the exemplary embodiment that is represented and preferred shows that a further plastics material may be used. In this respect it is provided in the represented exemplary embodiment of FIG. 2 that the lip 4 on the one hand and the sealing area 6 on the other hand consist of materials of different hardnesses. While the sealing cap 1 in the exemplary embodiment of FIG. 2 consists for example of a polypropylene, the sealing areas 6 consist by contrast of an elastomer, to be specific a thermoplastic elastomer (TPE), which is softer and provides the sealing effect.

The exemplary embodiment that is represented in FIG. 2 is distinguished by the fact that the sealing area 6 otherwise consists of a different material, to be specific a different plastic, than the sealing cap 1. In the exemplary embodiment represented, it is provided in this respect that the sealing area 6 is formed on the material of the sealing cap 1, preferably in a two-component injection-molding process. Other joining methods are also conceivable for the connection, for example adhesive bonding, clamping, welding, plug connection, etc.

In principle, it is also possible for example to coat the inner surface of the sealing cap 1 over a large two-dimensional area with an elastomer or some other material with particularly good sealing properties, and so merge the two sealing areas and form the sealing areas 6 two-dimensionally in this form only on the inner side of the sealing cap 1. That would be in particular to match up with a screw coupling of the sealing cap 1 on the receiving container 2. However, it would then be expedient to form the lips 4 of the openings 5 in a correspondingly convex manner or to provide them with some other convexity.

FIG. 3 diagrammatically shows another embodiment of a supply container according to the invention, having a head piece 2a′ and a cap 1′. The container is characterized in that the lip 4 consists of some other material than the receiving container otherwise consists, or a headpiece 2c′ of the receiving container otherwise consists. Here it is provided that the lip 4 is formed on the material of the receiving container or a head piece 2c′ of the receiving container, preferably by a two-component injection-molding process. In the case of this exemplary embodiment, the upper portion of the spouts 3a′ and 3b′ by which the lip 4 is respectively formed consists of a different material than the spouts 3 otherwise consist. While a polypropylene is otherwise used for example for the receiving container 2 with the spouts 3, the lip 4 is formed on both openings 5 as a thermoplastic elastomer (TPE) by the two-component injection-molding process. In the exemplary embodiment that is represented, the convexity on the sealing cap 1, which however consists of the material of the sealing cap 1 itself and is only formed on the sealing cap 1′, rests on the respective lip 4. Precisely in the case of this embodiment with an lip 4 of material that is expedient for sealing, for example an elastomer, a merely two-dimensional formation of the inner side of the sealing cap 1 can be successfully realized along with correspondingly convexly curved lips 4 of the openings 5, serving for the sealing effect.

It is obvious that a supply container as provided by the teaching of the present patent application may in particular be a dispensing bottle, such as that described in the earlier patent application to which reference is made, DE 102 38 431.2.

1. A supply container comprising
a receiving container having at least two compartments and a dispensing opening for each compartment, and a sealing cap,
said sealing cap being formed for simultaneously sealing said two openings, each of said openings being formed by a lip and,
said sealing cap having a sealing state in which it closes said openings, and means to releasably engage the receiving container and maintain the cap in sealing engagement with said openings,
said cap having a dedicated sealing area associated with each of said openings, each area adapted in the sealing state to abut its associated opening, and
positioning means on said receiving container cooperating with said sealing cap to precisely determine a sealing position for the cap in which the sealing areas bear on the lips with a small axial pressing force.

2. The supply container as claimed in claim 1, characterized in that the positioning means comprises abutting edges on the cap and the receiving container.

3. The supply container as claimed in claim 1, each sealing area being formed as a convexity on the sealing cap

4. The supply container as claimed in claim 3, wherein said convexity is lenticular or part spherical in shape.

5 The supply container as claimed in claim 1, wherein at least one of each lip and its associated sealing area consists of a thermoplastic material.

6. The supply container as claimed in claim 1, wherein at least one of said sealing cap and the receiving container consists of a thermoplastic material.

7. The supply container as claimed in claim 1, wherein at least one of each lip and its associated sealing area consists of an elastomer.

8. The supply container as claimed in claim 1, wherein at least one of each lip and its associated-sealing area on the one hand consists of a material of different hardness than the material of the other of the each lip and its associated sealing area, on the other hand.

9. The supply container as claimed in claim 4 wherein each lip consists of polypropylene.

10. The supply container as claimed in claim 4 wherein the sealing area consists of a thermoplastic elastomer.

11. The supply container as claimed in claim 1, wherein said lips and said sealing areas are plastic, at least one of each lip and its associated sealing area on the one hand consists of a plastic which is different than the plastic of the other of the each lip and its associated sealing area, on the other hand.

12. The supply container as claimed in claim 1, wherein the sealing areas are formed integrally with the sealing cap, as a two-component injection-molded product.

13. The supply container as claimed in claim 1, wherein the lips consist of a material different than the material of the receiving container adjoining said lips.

14. The supply container as claimed in claim 13, characterized in that the lips are formed on the adjoining material of the receiving container as a two-component injection-molded product.

15. The supply container as claimed in claim 1, wherein said receiving container has a first compartment for a first fluid containing active substance and at least one second compartment for a second fluid containing active substance, said compartments adjoining one another, and a common head piece forming discharge nozzles having the lips of the separate openings of said at least two compartments to provide openings for the outlet of the first and second fluids, said openings being adjacent one another in such a way that the two fluids can be applied in a common application zone of an application area,
said compartments being compressible containers and the openings being respectively positioned so that the two fluids are mixed with one another only after they leave the discharge nozzles.
